(19) United States
(12) Patent Application Publication
(10) Pub. No.: US 2011/0117425 A1
(43) Pub. Date: May 19, 2011

(54) SECONDARY BATTERY

(75) Inventors: Jung-Sup Kwak, Yongin-si (KR); Chang-Bum Ahn, Yongin-si (KR)

(73) Assignee: Samsung SDI Co., Ltd., Yongin-si (KR)

(21) Appl. No.: 12/838,798

(22) Filed: Jul. 19, 2010

(30) Foreign Application Priority Data
Nov. 19, 2009 (KR) 10-2009-0112198

(51) Int. Cl. H01M 2/02

(52) U.S. Cl. 429/177

(57) ABSTRACT

A secondary battery for reinforcing rigidity and having an easy venting structure. The secondary battery includes an electrode assembly for charging or discharging a power source; and a case for accommodating the electrode assembly and being sealed, wherein the case comprises: a first cover and a second cover, wherein the electrode assembly is accommodated in a space formed between the first cover and the second cover, wherein the first cover and the second cover are formed of different materials, and wherein the second cover

### CROSS-REFERENCE TO RELATED APPLICATIONS

This application claims the benefit of Korean Patent Application No. 10-2009-0112198, filed on Nov. 19, 2009, in the Korean Intellectual Property Office, the disclosure of which is incorporated herein in its entirety by reference.

### BACKGROUND OF THE INVENTION

1. Field of the Invention

One or more embodiments relate to a secondary battery, and more particularly, to a pouch type second battery formed by accommodating an electrode assembly in a pouch case and sealing the pouch case.

2. Description of the Related Art

Compact and lightweight portable electronic devices have rapidly developed and thus a demand for compact and high capacity batteries that are used as driving power sources for the portable electronic devices has increased. In particular, lithium ion secondary batteries operate at a voltage higher than 3.6 V, which is greater 3 times than nickel-cadmium (Ni-Cd) batteries or nickel-hydride (Ni-MH) batteries, and have a high energy density per unit weight and thus lithium ion secondary batteries are widely used as power sources for portable electronic devices.

Lithium ion secondary batteries generate electric energy resulting from an oxidation and deoxidation reaction when lithium ions are intercalated into and deintercalated from cathodes and anodes. Lithium ion secondary batteries may be fabricated by using reversibly intercalatible and deintercalatible materials as active materials of cathodes and anodes and charging an organic electrolyte or a polymer electrolyte between anodes and cathodes.

Secondary batteries may be fabricated in various ways. Secondary batteries may be classified into cylindrical batteries, quadrangular batteries, and pouch type batteries for example. Cylindrical batteries use cylindrical aluminum cans as cases. Quadrangular batteries use quadrangular aluminum cans as cases. Pouch type batteries use this plate pouches as cases.

### SUMMARY OF THE INVENTION

One or more embodiments include secondary batteries for both reinforcing rigidity and portions of this case having an easy venting structure.

Additional aspects will be for other portions of the case set forth in part in the description which follows and, in part, will be apparent from the description, or may be learned by practice of the presented embodiments.

According to one or more embodiments, a secondary battery including: an electrode assembly for charging or discharging a power source; and a case for accommodating the electrode assembly and being sealed, wherein the case comprises: a first cover and a second cover, wherein the electrode assembly is accommodated in a space formed between the first cover and the second cover, wherein the first cover and the second cover are formed of different materials, and wherein the second cover has strength against the surface pressure greater than the first cover.

For example, the rating capacity may be a medium/large size battery system comprised of two or more of the instant secondary batteries between about 4 Ah and about 1000 Ah.

The thickness of the second cover may be greater than that of the first cover.

The secondary battery may further include: sealing portions for sealing the space in which the electrode assembly is accommodated by bonding the sealing portions of the first cover and the portions sealing of the second cover to each other.

The secondary battery may further include: space portions for accommodating the electrode assembly between the opposing first second covers.

The first cover may include: a metal layer formed of a metal material; an exterior layer formed on a surface facing the outside of the metal layer; and an interior layer formed on a surface facing the inside of the metal layer.

The second cover may include: a metal layer formed of a metal material; an exterior layer formed on a surface facing the outside of the metal layer; and an interior layer formed on a surface facing the inside of the metal layer.

The thickness of the metal layer of the second cover may be greater than that of the metal layer of the first cover.

The thickness of the metal layer of the first cover may be between about 40 μm and about 50 μm, and the thickness of the metal layer of the second cover may be between about 100 μm and about 250 μm.

The second cover may further include: a second exterior layer formed on a surface facing the outside of the exterior layer.

A melting point of the interior layer of the first cover may be lower than that of the interior layer of the second cover.

The melting point of the interior layer of the first cover may be between about 80° C. and about 120° C., and the melting point of the interior layer of the second cover may be between about 130° C. and about 200° C.

The secondary battery may further include: sealing portions for sealing the space in which the electrode assembly is accommodated by thermally cohering a portion of the interior layer of the first cover and a portion of the interior layer of the second cover that contact each other.

The interior layer of the first cover may include polyethylene (PE) or a PE polymer,

The interior layer of the second cover may include polyolefine or casted polypropylene (CPP) or PP as a main component.

Two or more cases in which the electrode assembly may be accommodated are stacked in the secondary battery.

According to one or more embodiments, a secondary battery include an electrode assembly for charging or discharging a power source; and a case for accommodating the electrode assembly and being sealed, wherein the case comprises: a first cover and a second cover, wherein the electrode assembly is accommodated in a space formed between the first cover and the second cover, wherein the first cover and the second cover are formed of different materials, and wherein a melting point of a surface of the first cover that contacts the second cover is lower than that of a surface of the second cover that contact the first cover.

The rating capacity of one or more secondary batteries may be a medium/large size battery system between about 4 Ah and about 1000 Ah.

The melting point of the first cover may be between about 80° C. and about 120° C., and the melting point of the second cover may be between about 130° C. and about 200° C.

The melting point of the first cover may be between about 90° C. and about 110° C.

The thickness of the second cover may be greater than that of the first cover.

The thickness of the first cover may be between about 100 μm and about 150 μm, and the thickness of the second cover may be between about 150 μm and about 300 μm.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of a secondary battery according to an embodiment;

FIG. 2 is an exploded perspective view of the secondary battery of FIG. 1 according to an embodiment;

FIG. 3 is a schematic cross-sectional view of a first cover of the secondary battery of FIG. 1 according to an embodiment;

FIG. 4 is a schematic cross-sectional view of a second cover of the secondary battery of FIG. 1 according to an embodiment and

FIG. 5 is a schematic perspective view of a battery system in which a plurality of the second batteries of FIG. 1 is stacked according to an embodiment.

### DETAILED DESCRIPTION OF THE INVENTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

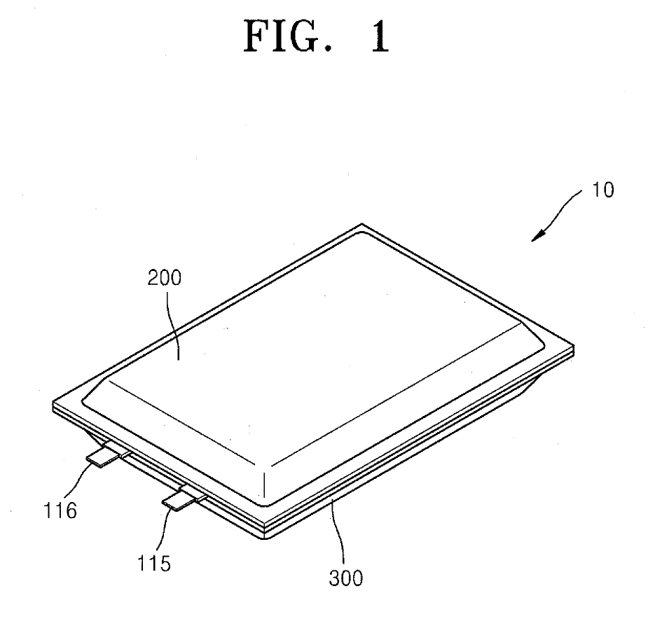

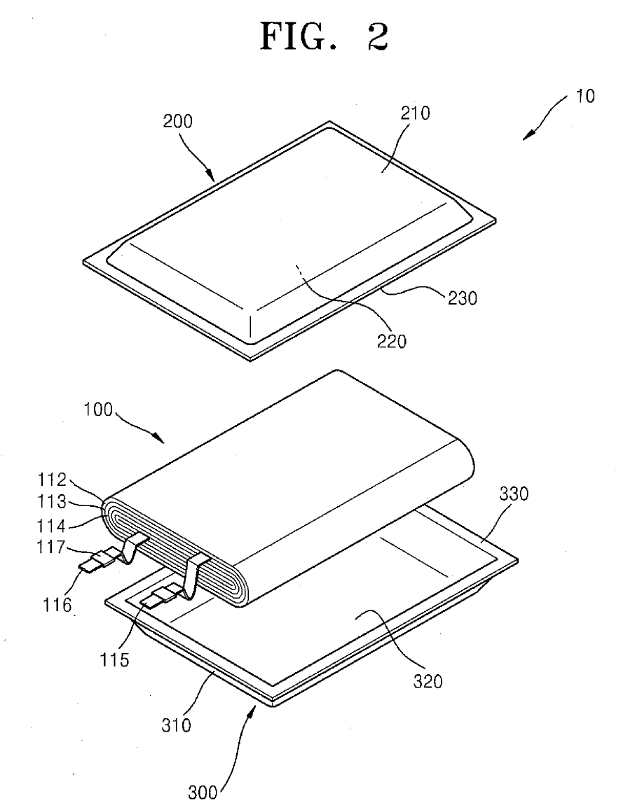

FIG. 1 is a perspective view of a secondary battery 10 according to an embodiment. FIG. 2 is an exploded perspective view of the secondary battery 10 according to an embodiment.

Referring to FIGS. 1 and 2, the secondary battery 10 includes an electrode assembly 100 and a case comprised of covers 200 and 300. The electrode assembly 100 charges or discharges a power source. The case, which includes a first cover 200 and a second cover 300 which covers are shaped to accommodate the electrode assembly 100 therein and are sealed together.

The electrode assembly 100 is accommodated in the void disposed between the first cover 200 and the second cover 300. In this regard, the first cover 200 and the second cover 300 may be formed of different materials. In some embodiments, when pressure is applied to the second cover 300, it has a rigidity greater than that of the first cover is more rigid thus able to withstand high and low pressures better than the first cover 200 when pressure is applied to the first cover.

In some embodiments, the thickness of the second cover 300 may be greater than that of the first cover 200. In this case, the thickness of the first cover 200 may be from about 100 μm to about 150 μm, and the thickness of the second cover 300 may be from about 150 μm to about 300 μm.

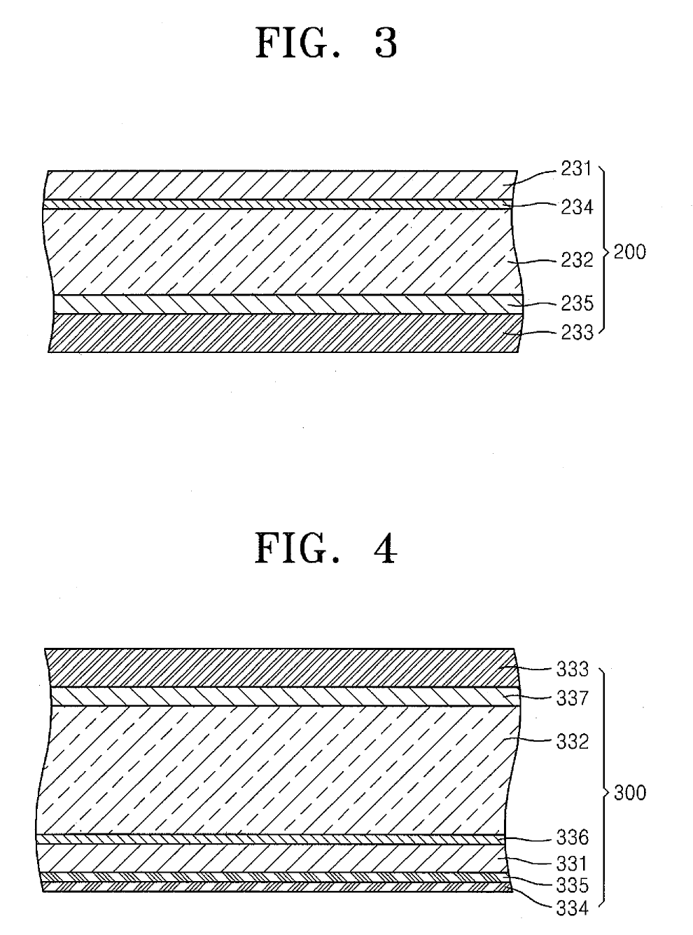

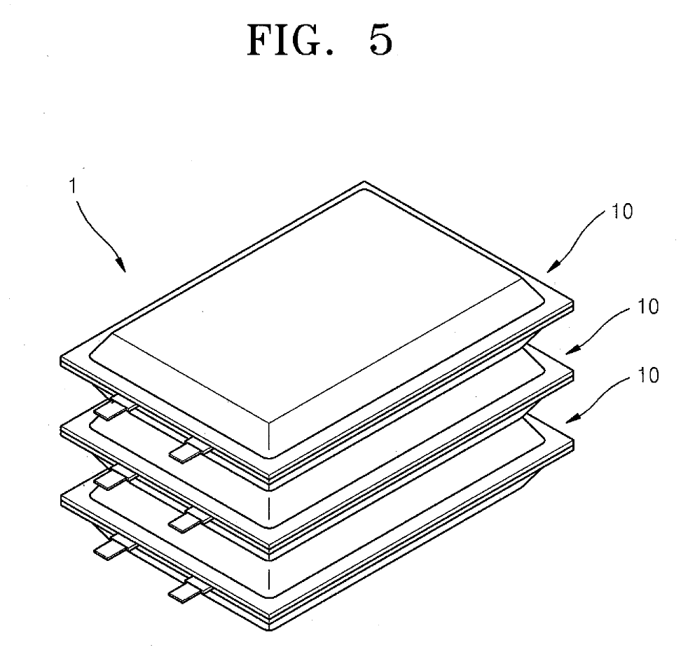

The second battery 10 may be a pouch type battery that forms the case for accommodating the electrode assembly 100 by using thin plate pouches as the first cover 200 and the second cover 300. For example, a general pouch cover may be used as the first cover 200 as shown in FIG. 3, and a high strength pouch cover may be used as the second cover 300 as shown in FIG. 4.

In some embodiments, the case formed by the first cover 200 and the second cover 300 that are formed of different materials, is a drape to accommodate the electrode assembly 100 therein, and are sealed.

The highly strength pouch is used as the second cover 300, making it possible to maintain a pouch shape while the secondary battery 10 is used for a long period of time, thereby preventing the electrode assembly 100 from being distorted.

Further, while the secondary battery 10 is used for a long period of time, an electrolyte may slow away from to one side of the secondary battery 10. According to the present embodiments, the electrode assembly 100 is less likely to be damaged during a manufacturing process of the secondary battery 10.

A general pouch cover, which is less rigid than the highly strong pouch cover used as the second cover 300, is used as the first cover 200, and thus the general pouch cover is at a lower temperature when compared to the high strong pouch, thereby allowing the battery 10 to vent.

The secondary battery 10 of the present embodiment may be applied to a medium/large battery system 1 that forms a single battery system, such as a hybrid electric vehicle (HEV) or a power storage system, by stacking a plurality of unit battery cells as shown in FIG. 5.

In this case, the battery system 1 may be the medium/large battery system 1 having a current charge and discharge rate (C-rate) during an average discharge greater than 20 C or having a rating capacity greater than about 4 Ah from about 4 Ah to about 1000 Ah for power consumption greater than 20 wh.

The battery system 1 may be formed by stacking a plurality of secondary batteries 10 with reference to FIG. 5. So such if one of the secondary battery 10 in the sail batteries system it can be readily identified can be identified from a plurality of cells used in the secondary battery 10. The battery system 1 may then be returned to normal operation by removing the defective cell.

At a set temperature, for example, from about 80° C. to about 120° C., set in the defective one or more of the secondary batteries battery among the plurality of secondary batteries 10 included in the battery system 1 sails by having, the first cover 200, which is less rigid than the second cover 300, structures and allows the battery to vent.

Vacuum is released and thus an air flows into the secondary battery 10, and moisture contained in the air reacts with the electrode assembly 100, causing a voltage imbalance and increasing the resistance in the ruptured—secondary battery 10. Therefore, a of the battery system 1 defective secondary battery 10 can be easily selected by a sensor (not shown) installed in the secondary batteries 10 included in the battery system 1.

When the first cover 200 which is less rigid than the second cover 300 and this defective secondary battery 10 explodes at a relatively low temperature, the secondary batteries 10 neighboring the defective secondary battery 10 may be less affected. If the first cover 200 ruptures at a temperature from about 80° C. to about 120° C., the secondary batteries 10 may be operated below a temperature of about 70° C.

The first cover 200 and the second cover 300 may be formed in such a way that the melting point of the surface of the first cover 200 that contacts the second cover 300 is lower than that of a surface of the second cover 300 that contacts the first cover 200. The embodiments of the first cover 200 and the second cover 300 are illustrated in FIGS. 3 and 4.

The melting point of the first cover 200 may be from about 80° C. to about 120° C., and the melting point of the second cover 300 may be from about 130° C. to about 200° C. In some embodiments, the melting point of the first cover 200 may be from about 90° C. to about 110° C.

Thus, if the temperature of the secondary battery 200 reaches from about 90° C. to about 110° C. that is the melting point of the first cover 200, the first cover 200 which is less rigid than the second cover 300 may fracture and vent.

The secondary battery 10 may include the electrode assembly 100 and the pouch type case including the first cover 200 and the second cover 300 that surround and seal the electrode assembly 100. The secondary battery 10 may be formed by stacking a plurality of separators 113 disposed between a first electrode 112 and a second electrode 114 or winding the separators 113 in a jelly roll type structure.

Protection tape 117 is bonded to the surface of a first electrode tap 115 and the surface of a second electrode tap 116 that extend from one side of each electrode plate of the electrode assembly 100 so that the first electrode tap 115 and the second electrode tap 116 may partially protrude toward the outside of the pouch type case (refer to FIG. 1).

Sealing portions 230 and 330 may be formed on a marginal portion of the first cover 200 and a marginal portion of the second cover 300, respectively, by bonding the marginal portion of the first cover 200 and the marginal portion of the second cover 300 and sealing a space in which the electrode assembly 100 is accommodated. The space portions 220 and 320 for accommodating the electrode assembly 100 may be formed between the first cover 200 and the second cover 300 that face each other.

The space portions 220 and 320 may be formed in cover bodies 210 and 310 that are formed of different materials, respectively, by separating the first cover 200 and the second cover 300 from each other. The space portions 220 and 320 may be formed in a quadrangular shape in the first cover 200 and the second cover 300, and the sealing portions 230 and 330 may be formed on four surfaces of the first cover 200 and the second cover 300 to surround the space portions 220 and 320.

The electrode assembly 100 is accommodated in the space portions 220 and 320 formed in the first cover 200 and the second cover 300, respectively, and the sealing portions 230 and 330 that face each other are sealed by a thermal cohesion by tightly adhering the first cover 200 and the second cover 300 each other, thereby forming the pouch type cases 200 and 300.

The space portions 220 and 320 are formed in the first cover 200 and the second cover 300, respectively, in the present embodiment. However, the present embodiments are not limited thereto and the space portions 220 and 320 may be formed in any one of the first cover 200 and the second cover 300.

The first cover 200 and the second cover 300 may have a plate shape formed by stacking a plurality of film layers that are formed of different materials. In this case, the space portions 220 and 320 are not formed in the first cover 200 and the second cover 300, respectively, the electrode assembly 100 is disposed between the first cover 200 and the second cover 300, and the sealing portions 230 and 330 are sealed, thereby forming the pouch type cases 200 and 300.

FIG. 3 is a schematic cross-sectional view of the first cover 200 of the secondary battery 10 according to an embodiment. Referring to FIG. 3, the first cover 200 may include a metal layer 232, an exterior layer 231, and an interior layer 233. The metal layer 232 may be formed of a metal material. The exterior layer 231 may be formed on a surface facing the outside of the metal layer 232. The interior layer 233 may be formed on a surface facing the inside of the metal layer 232.

FIG. 4 is a schematic cross-sectional view of the second cover 300 of the secondary battery 10 according to an embodiment. Referring to FIG. 4, the second cover 300 may include a metal layer 332, an exterior layer 331, and an interior layer 333. The metal layer 332 may be formed of a metal material. The exterior layer 331 may be formed on a surface facing the outside of the metal layer 332. The interior layer 333 may be formed on a surface facing the inside of the metal layer 332.

In this regard, a thickness of the metal layer 332 of the second cover 300 may be greater than that of the metal layer 232 of the first cover 200. Thus, the second cover 300 may have greater strength against surface pressure greater than the first cover 200. The thickness of the metal layer 232 of the first cover 200 may be between about 40 μm and about 50 μm, and the thickness of the metal layer 332 of the second cover 300 may be between about 100 μm and about 250 μm.

The second cover 300 may further include a second exterior layer 334 formed on a surface facing the outside of the exterior layer 331 and thus a thickness of the second cover 300 may be greater than that of the first cover 200. Further, the second cover 300 may have strength against surface pressure greater than the first cover 200.

The sealing portions 230 and 330 that are formed in the interior layer 233 of the first cover 200 and the interior layer 333 of the second cover 300 are thermally cohered to each other, thereby sealing the cases 200 and 300 in which the electrode assembly 100 is accommodated.

The melting point of the interior layer 233 of the first cover 200 is lower than that of the interior layer 333 of the second cover 300. The melting point of the interior layer 233 of the first cover 200 may be between about 80° C. and about 120° C., and the melting point of the interior layer 333 of the second cover 300 may be between about 130° C. and about 200° C. In this regard, the melting point of the interior layer 233 of the first cover 200 may be between about 90° C. and about 110° C.

Thus, if the temperature of the secondary battery 200 reaches between about 90° C. and about 110° C. that is the melting point of the interior layer 233 of the first cover 200, the first cover 200 may and the battery would vent.

Meanwhile, the first cover 200 may include adhesive layers 234 and 235 in which adhesives are disposed between the metal layer 232 and the exterior layer 231 and between the metal layer 232 and the interior layer 233, respectively. In this regard, the metal layer 232, the exterior layer 231, and the interior layer 233 may be thermally cohered to each other without the adhesive layers 234 and 235.

Meanwhile, the first cover 300 may include adhesive layers 335, 336, and 337 in which adhesives are disposed between the metal layer 332 and the exterior layer 331, between the metal layer 332 and the interior layer 333, and between the exterior layer 331 and the second exterior layer 334, respectively. However, these adhesives are optional, the metal layer 332, the exterior layer 331, the interior layer 333, and the second exterior layer 334 may be thermally cohered to each other without the adhesive layers 335, 336, and 337.

The interior layer 233 of the first cover 200 may include polyethylene (PE) or a PE polymer. The interior layer 333 of the second cover 300 may include polyolefine or casted polypropylene (CPP) or PP as a main component. Thus, the interior layer 233 of the first cover 200 may be melt at a lower temperature than the interior layer 333 of the second cover 300.

The function of the metal layers 232 and 332 maintain appropriate thicknesses, prevent moisture and gas from passing into the secondary battery 10, prevent an electrolyte from leaking, and maintain the rigidity of the pouch type case of the secondary battery 10. The metal layers 232 and 332 may be formed of any one selected from an alloy of iron (Fe), carbon (C), chromium (Cr), and manganese (Mn), an alloy of Fe, C, Cr, and nickel (Ni), aluminum (Al), and equivalents thereof. However, the present embodiments are not limited thereto and the metal layers 232 and 332 may be formed of aluminum (Al) having good flexibility.

The exterior layers 231 and 331 may be coated or laminated to a predetermined thickness on a surface facing the outside of the metal layers 232 and 332. The interior layers 233 and 333 may be coated or laminated to a predetermined thickness on a surface facing the inside of the metal layers 232 and 332.

According to the present embodiments, a secondary battery portions of the case of the battery may have increased rigidity while other are less rigid, providing a case that ruptures easily to vent the battery rigidity and have an easy venting structure.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A secondary battery comprising:
an electrode assembly for charging or discharging a power source; and
a sealed case configured to accommodate the electrode assembly,
wherein the case comprises: a first cover and a second cover,
wherein the electrode assembly is accommodated in a space formed between the first cover and the second cover,
wherein the first cover and the second cover are formed of different materials, and
wherein the second cover has a surface strength greater than that of the first cover.

2. The secondary battery of claim 1, wherein a rating capacity of the secondary battery in a medium/large size battery systems from about 4 Ah to about 1000 Ah.

3. The secondary battery of claim 1, wherein the thickness of the second cover is greater than that of the first cover.

4. The secondary battery of claim 1, further comprising: sealing portions for sealing the space in which the electrode assembly is accommodated by bonding a portion of the first cover and a portion of the second cover to each other.

5. The secondary battery of claim 4, further comprising: space portions for accommodating the electrode assembly between the first cover and the second cover that face each other.

6. The secondary battery of claim 1, wherein the first cover comprises:
a metal layer formed of a metal material;
an exterior layer formed on a surface facing the outside of the metal layer; and
an interior layer formed on a surface facing the inside of the metal layer.

7. The secondary battery of claim 6, wherein the second cover comprises:
a metal layer formed of a metal material;
an exterior layer formed on a surface facing the outside of the metal layer; and
an interior layer formed on a surface facing the inside of the metal layer.

8. The secondary battery of claim 7, wherein a thickness of the metal layer of the second cover is greater than that of the metal layer of the first cover.

9. The secondary battery of claim 8, wherein the thickness of the metal layer of the first cover is from about 40 μm to about 50 μm, and the thickness of the metal layer of the second cover is from about 100 μm to about 250 μm.

10. The secondary battery of claim 7, wherein the second cover further comprises: a second exterior layer formed on a surface facing the outside of the exterior layer.

11. The secondary battery of claim 7, wherein a melting point of the interior layer of the first cover is lower than that of the interior layer of the second cover.

12. The secondary battery of claim 11, wherein the melting point of the interior layer of the first cover is from about 80° C. to about 120° C., and the melting point of the interior layer of the second cover is from about 130° C. to about 200° C.

13. The secondary battery of claim 7, further comprising: sealing portions for sealing the space in which the electrode assembly is accommodated by thermally cohering a portion of the interior layer of the first cover and a portion of the interior layer of the second cover that contact each other.

14. The secondary battery of claim 7, wherein the interior layer of the first cover comprises polyethylene (PE) or a PE polymer.

15. The secondary battery of claim 7, wherein the interior layer of the second cover comprises polyolefine or casted polypropylene (CPP) or PP as a main component.

16. The secondary battery of claim 1, wherein two or more cases in which the electrode assembly is accommodated are stacked to form a secondary battery system.

17. A secondary battery comprising:
an electrode assembly for charging or discharging a power source; and
a sealed case configured to accommodate the electrode assembly,
wherein the case comprises: a first cover and a second cover,
wherein the electrode assembly is accommodated in a space formed between the first cover and the second cover,
wherein the first cover and the second cover are formed of different materials, and
wherein a melting point of a surface of the first cover that contacts the second cover is lower than that of a surface of the second cover that contact the first cover.

18. The secondary battery of claim 17, wherein a rating capacity of the secondary battery is a medium/large size from about 4 Ah to about 1000 Ah.

19. The secondary battery of claim 17, wherein the melting point of the first cover is from about 80° C. to about 120° C., and the melting point of the second cover is from about 130° C. to about 200° C.

20. The secondary battery of claim 19, wherein the melting point of the first cover is from about 90° C. to about 110° C.

21. The secondary battery of claim 17, wherein a thickness of the second cover is greater than that of the first cover.

22. The secondary battery of claim 21, wherein the thickness of the first cover is from about 100 μm to about 150 μm, and the thickness of the second cover is from about 150 μm to about 300 μm.

23. The secondary battery of claim 17, wherein two or more cases in which the electrode assembly is accommodated are stacked in the secondary battery.
